(19) United States
(12) Patent Application Publication
(10) Pub. No.: US 2009/0213593 A1
(43) Pub. Date: Aug. 27, 2009

(54) Optical device and system for black level enhancement and methods of use thereof

(75) Inventors: Michael F. Foley, Avon, CT (US); James F. Munro, Walworth, NY (US)

Correspondence Address: NIXON PEABODY LLP - PATENT GROUP, 1100 CLINTON SQUARE, ROCHESTER, NY, 14604, US

(73) Assignee: Reflexite Corporation, Avon, CT (US)

(21) Appl. No.: 12/072,314

(22) Filed: Feb. 26, 2008

(51) Int. Cl. F21V 5/02

(52) U.S. Cl. 362/333

(57) ABSTRACT

The present invention relates to an optical device for black level enhancement of a viewing display. Also disclosed are a system including the optical device and methods of improving black level of a viewing display, such as a plasma display panel, a liquid crystal display panel, an inorganic light emitting diode display panel, or an organic light emitting diode display panel.

### FIELD OF THE INVENTION

The present invention relates to an optical device for black level enhancement of a viewing display, such as a plasma display panel, a liquid crystal display (“LCD”) panel, an inorganic light emitting diode (“iLED”) display panel, or organic light emitting diode (“OLED”) display panel and methods thereof.

### BACKGROUND

Flat panel screens, in particular plasma display panels (PDPs), enable color pictures with high definition, large screen diagonals and have a compact structure. A plasma screen comprises a gas-filled sealed glass cell with grid-like arranged electrodes. By applying an electric voltage, a gas discharge is caused which mainly generates light in the vacuum ultraviolet range (“VUV”). Fluorescence transforms this VUV light into visible light and the front plate of the glass cell emits this visible light to the viewer.

When compared to LCD-type large area displays or televisions, PDPs suffer from poor black levels, and therefore comparably poor contrast. The poor black level performance is most evident when ambient room light shines on the plasma TV, and the high reflectance of the whitish-gray light emitters causes the blackest black that is displayed on the PDP to appear whitish-gray. Since LCD and plasma TV's are now comparable in selling price, contrast performance is becoming a deciding factor in the purchase of a flat panel TV. Plasma TV manufacturers are searching for a simple and low-cost method of improving the black level of their displays, that does not degrade other PDP performance characteristics, such as resolution and on-axis luminance or brightness.

A prior-art method for improving the black-level of a PDP is presented in FIG. 1. In this setup, PDP pixels 10A and 10B are situated behind a glass layer 12 of the display panel onto which is installed a film 15 for ambient light absorption. The ambient light absorption film 15 has a substrate 18 onto which is installed a series of black light-absorbing strips 14 between which are transparent apertures 16. The front face 20 of the ambient light absorption film 15 is transparent, but may be textured to reduce ambient light glare.

In operation, ambient light ray 30 that originates from a light source in the vicinity of the PDP, typically from an overhead room light, is incident on the front face 20 and refracts into the substrate 18 before striking a black stripe 14 at location 40 where it is absorbed. In this way ambient light is absorbed and prevented from reaching the highly reflective pixels 10A and 10B. However, light rays such as ray 32 refract through the front surface 20 into the substrate 18, but then miss the black stripes 14 and pass through an aperture 16 unattenuated. This ray then passes through the glass layer 12 and is then incident on a PDP pixel 10A, at location 44 whereupon it is backscattered into a full hemisphere. Some of the backscattered light, such as ray 36, will be incident on a black stripe and be absorbed, such as at location 48. However other rays, such as ray 34, will pass through an aperture 46 between the black stripes and will exit the PDP system. These rays can be easily seen by the TV viewer, and degrade the viewing performance of the PDP by making the black colors appear gray, and by making the saturated colors appear dingy and pale.

The ambient light absorption film 15 also impacts the brightness of the PDP because a large portion of the light rays emitted by the pixels are absorbed by the black stripes. For example, light ray 62 emitted from pixel 10B at location 52 passes through the glass 12 and immediately strikes the backside of a black stripe at location 54 and is absorbed. On the other hand, light ray 64 emitted from pixel 10B at location 50 is able to pass through an aperture of the ambient light absorption film 15 at location 56 unattenuated.

To obtain maximum brightness then, the ratio of the width of the apertures 16 to the pitch of the black stripes needs to be maximized. But this is at odds with how black-level performance is maximized, and typically a trade-off between transmittance and ambient light absorption must be made at the light absorption film 15. Because of this compromise generally both the light transmission of the film and the ambient light absorption characteristics are deemed to be inferior to the performance of the LCD-type displays. Consequently there is a genuine need for an ambient light absorption film that has high display light transmission and also high ambient light absorption. The present invention is directed to overcoming these and other deficiencies in the art.

### SUMMARY OF THE INVENTION

An optical device in accordance with embodiments of the present invention includes a microstructure layer having first and second opposing surfaces, wherein the microstructure layer comprises a plurality of transparent microstructures which form a plurality of spaced grooves, said grooves being at least partially filled with an opaque material and positioned to create alternating opaque and transparent sections having refractive index values within 0.03, and a transparent substrate adjacent at least a portion of the first surface of the microstructure layer.

A system for improving black level of a viewing display in accordance with embodiments of the present invention includes the optical device and a viewing display, wherein the second surface of the microstructure layer is adjacent at least a portion of the viewing display.

A method for improving contrast of a viewing display in accordance with embodiments of the present invention includes providing an optical device including a microstructure layer having first and second opposing surfaces, wherein the microstructure layer comprises a plurality of transparent microstructures which form a plurality of spaced grooves, said grooves being at least partially filled with an opaque material and positioned to create alternating opaque and transparent sections having refractive index values within 0.03, and a transparent substrate adjacent at least a portion of the first surface of the microstructure layer. At least a portion of the second surface of the microstructure layer is positioned adjacent at least a portion of an output surface of a viewing display, wherein a portion of ambient light is absorbed by the optical device before reaching the viewing display and a portion of ambient light reflected from the viewing display is absorbed by the optical device.

Accordingly, the present invention provides devices, systems, and methods for improving the black level and/or contrast of viewing displays, such as plasma display panels, LCD display panels, iLED display panels, and OLED display panels. The devices, systems, and methods of the present invention do not degrade other performance characteristics, such as resolution. In particular, light from the display panel passes through the transparent prisms, whereas ambient light will generally strike the blackened areas between the transparent prisms, and be absorbed. In this way ambient light absorption is maximized without unduly impacting display light transmittance through the film. Additionally, the present invention provides a microstructured optical device that is easy and inexpensive to manufacture and which has a compact design.

### BRIEF DESCRIPTION OF THE DRAWINGS

FIG. 1 is a partial, cross-sectional view of a prior art device for improving the black level of a plasma display panel;

FIG. 2 is a partial, cross-sectional view of an optical device and system in accordance with exemplary embodiments of the present invention;

FIG. 3 is a partial cross-sectional view of the optical device and system illustrated in FIG. 2 showing the various rays and symbols used to analyze and eliminate the pixel-ghosting problem that arises in the present invention;

FIG. 4 is a partial, cross-sectional view of an alternate embodiment of an optical device and system in accordance with exemplary embodiments of the present invention;

FIG. 5 is a partial, front view of an optical device and system in accordance with exemplary embodiments of the present invention which includes a microstructured optical device installed atop the pixels of a display panel in which the microstructure runs horizontally;

FIG. 6 is a partial, front view of an optical device and system in accordance with exemplary embodiments of the present invention which includes a microstructured optical device installed atop the pixels of a display panel in which the microstructure runs vertically;

FIGS. 7A-G are tables illustrating the dependency of the reflectance from an opaque region on the refractive index of the transparent microstructure, the index of the opaque microstructure, and the angle of incidence of the incident light, in accordance with exemplary embodiments of the present invention for improving the black level of a display panel;

FIG. 8 is a partial, cross-sectional view of an optical device and system in accordance with exemplary embodiments of the present invention in which the sides of the opaque sections are curved; and

FIG. 9 is a partial, cross-sectional view of an optical device and system in accordance with exemplary embodiments of the present invention in which the substrate of the optical device is located at the display panel side.

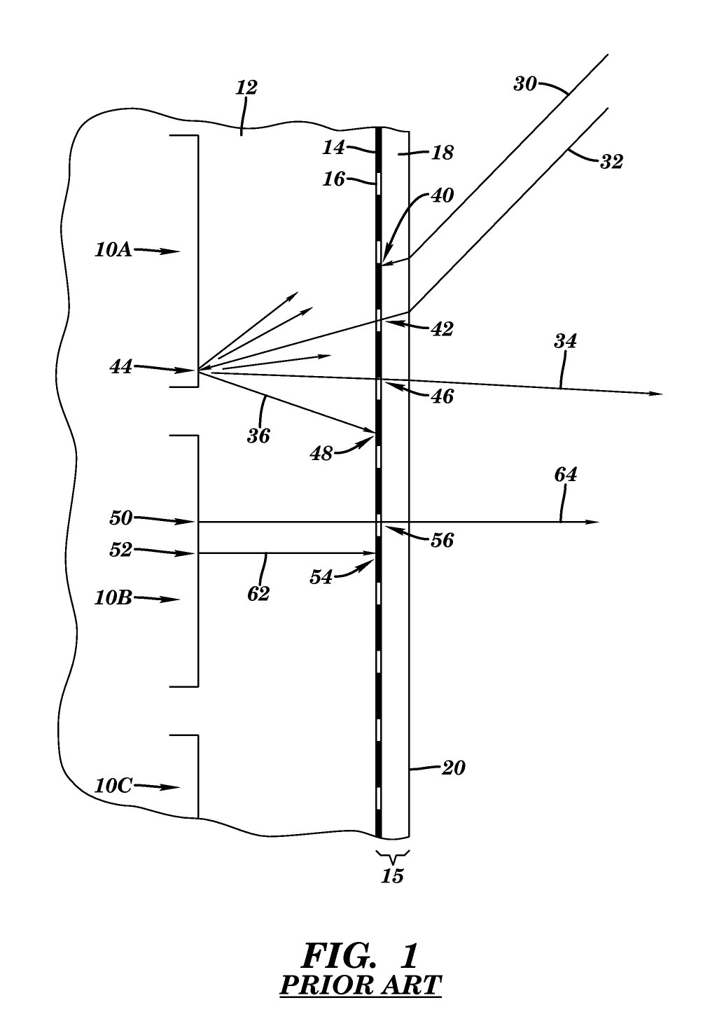

### DETAILED DESCRIPTION

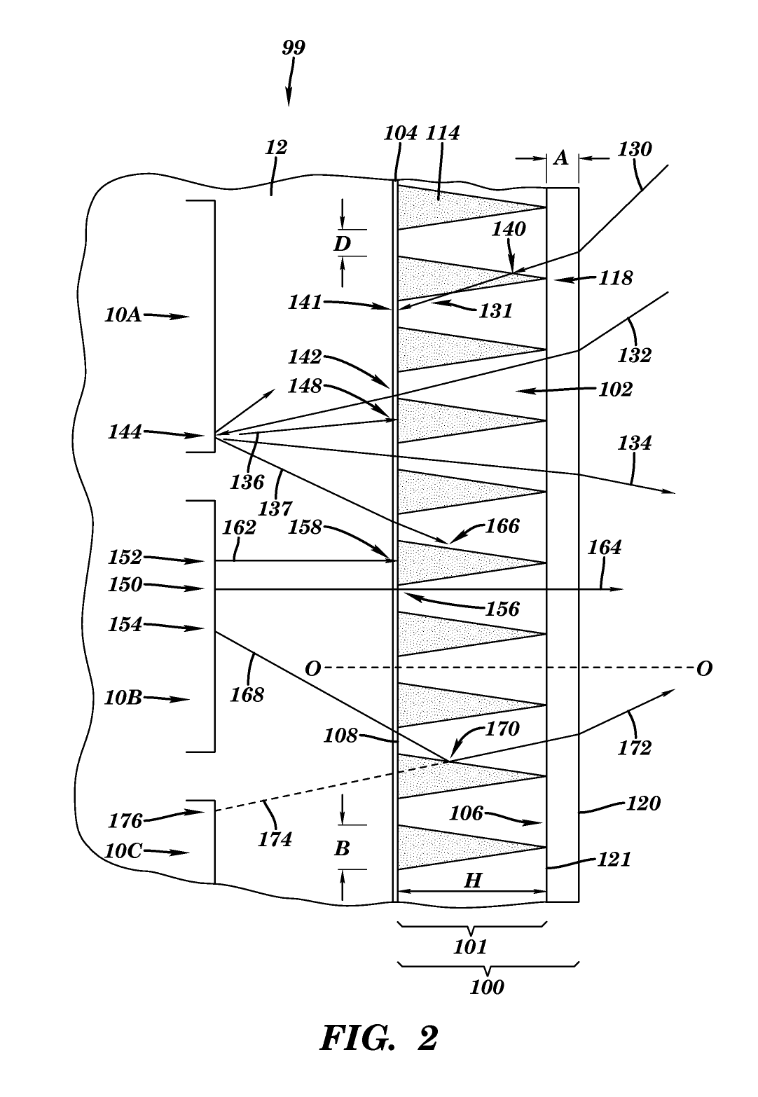

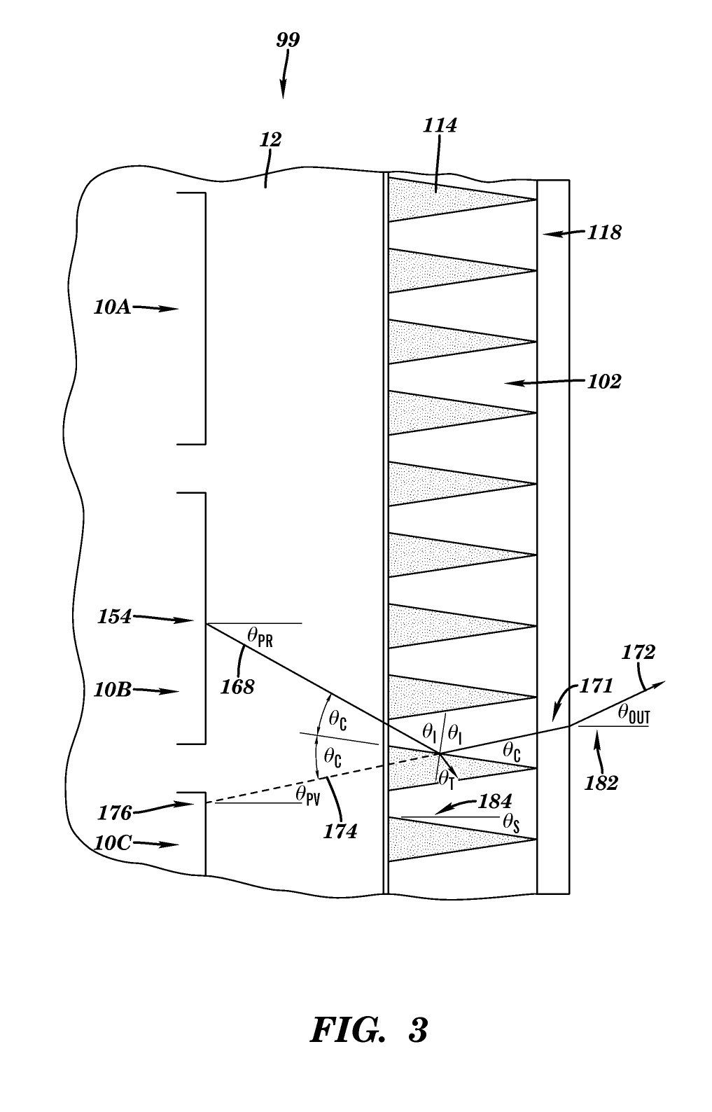

A system 99 including a microstructured optical device 100 in accordance with embodiments of the present invention is illustrated in FIGS. 2-4. Referring to FIGS. 2 and 3, the optical device 100 includes a substrate 118 comprising a transparent material. Suitable transparent materials include, but are not limited to, polymer sheets or films, such as acrylics, polycarbonates, vinyls, polyethylene terephthalate (“PET”), and polyethylene naphthalate (“PEN”). In one embodiment, as shown in FIG. 2, the substrate 118 has a thickness A of from about 0.02 mm to about 10 mm. In another embodiment, the refractive index of the substrate 118 is between 1.4 and 1.6, although lower values of index are preferable to minimize fresnel reflections from the front and rear surfaces. Referring to FIG. 2, the substrate 118 has a first surface 120 and a second surface 121. In one embodiment, the first surface 120 of the substrate, i.e. that which faces the viewer, is treated with an anti-reflective coating or a subwavelength antireflective microstructure to minimize reflections from surface 120. Furthermore, in another embodiment, first surface 120 has a diffusive surface relief texture to minimize specular glare.

Referring to FIG. 2, adjacent at least a portion of the second surface 121 of substrate 118 is a microstructure layer 101 having a first surface 106 and an opposing second surface 108. In one embodiment, the microstructure layer 101 has a thickness of from about 0.01 mm to about 1 mm. Normally first surface 106 is a planar, optically smooth surface. First surface 106 is adjacent and in contact with substrate 118.

The microstructure layer 101 includes a plurality of transparent microstructures 102. As used herein, a plurality includes more than one. The microstructures 102 are linear prisms or lenticulars, and can have a trapezoidal cross-sectional shape as shown in FIG. 2, although other cross-sectional shapes such as triangular, rectangular, or square, are possible. If the cross-sectional shape of the transparent microstructures 102 is triangular, the triangle can be isosceles, or it can be tilted, asymmetric, or otherwise non-isosceles so that the ambient light absorption, the display light emission, or both, can be asymmetric. Furthermore, although the sides of the microstructures 102 are shown as straight in FIGS. 2-4, other embodiments are possible, including curved sides (see description below). The bases of the microstructures 102 at the first surface 106, which are adjacent the substrate 118, may be touching, or may be spaced apart.

In one embodiment, the transparent microstructures 102 are fabricated from UV curable resin in a casting process, or they can be made with a molding process such as injection molding or embossing, using any suitable material, such as acrylic, polycarbonate, or vinyl. In another embodiment, the refractive index of the transparent microstructures 102 is between 1.4 and 1.6, although lower indices perform better as described below. In yet another embodiment, the transparent microstructures 102 have an aspect ratio of from about 0.5 to about 3.0. Normally the transparent microstructures 102 have minimal amounts of haze, although some haze may be beneficial to overcome the louvering effects imparted by the opaque material 114 on the light emitted by the display panel. Furthermore, the normally transparent microstructures 102 can have bulk diffusive properties obtained by dispersing particles of a different refractive index throughout the transparent microstructures 102.

The transmittance of the transparent microstructures 102 should not be spectrally dependent, but instead should transmit all wavelengths approximately the same between 400 nm and 700 nm so that it does not impart a strong tint to the viewed image. However, if a mild tint is imparted, the spectral emissive properties of the display panel can be changed to reduce or eliminate the effect. Alternately, tinting can be intentionally added to the transparent microstructures 102 or to the substrate 118 to compensate for spectral irregularities of the light emitted by the display panel. Furthermore, IR absorbing additives can be provided that reduce the amount of infra-red light that is emitted by the display. Such IR emissions have been known to disrupt IR-based handheld remote controls, and blocking these emissions would be beneficial.

Referring to FIGS. 2 and 3, the microstructures 102 form a plurality of triangular-shaped grooves in the microstructure layer 101, which extend from the second surface 108. The angle of the sidewalls of the triangular-shaped grooves in FIGS. 2 and 3 is from about 2° to about 20°, most preferably from about 4° to about 8°, from a line parallel to the optical axis O. As shown in FIGS. 2 and 3, in this embodiment, the triangular-shaped grooves extend from the first surface 106 at the narrow end of the triangle to the second surface 108 at the wide end of the triangle (i.e., they taper toward the substrate 118). However, in alternative embodiments, the grooves may extend only partially within the microstructure layer (i.e., in this embodiment, the grooves do not extend from first surface 106 to second surface 108).

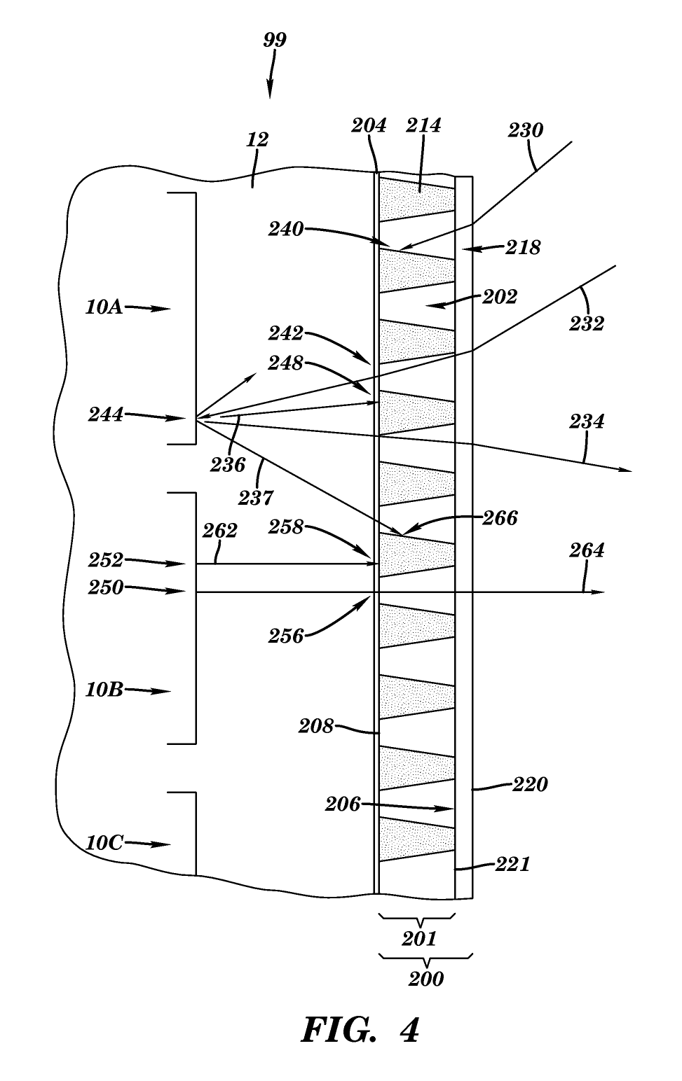

Although in this embodiment of the present invention, the microstructure layer 101 includes symmetric triangular-shaped grooves (i.e., isosceles triangle-shaped grooves in cross-section), other shapes of grooves may be used including, but not limited to, non-isosceles triangles, rectangular, square, and trapezoidal, and their side and base surfaces can be flat as shown in FIGS. 2 and 3, or one of more of them can be curved or non-linear. An example of trapezoidal-shaped grooves is shown in FIG. 4.

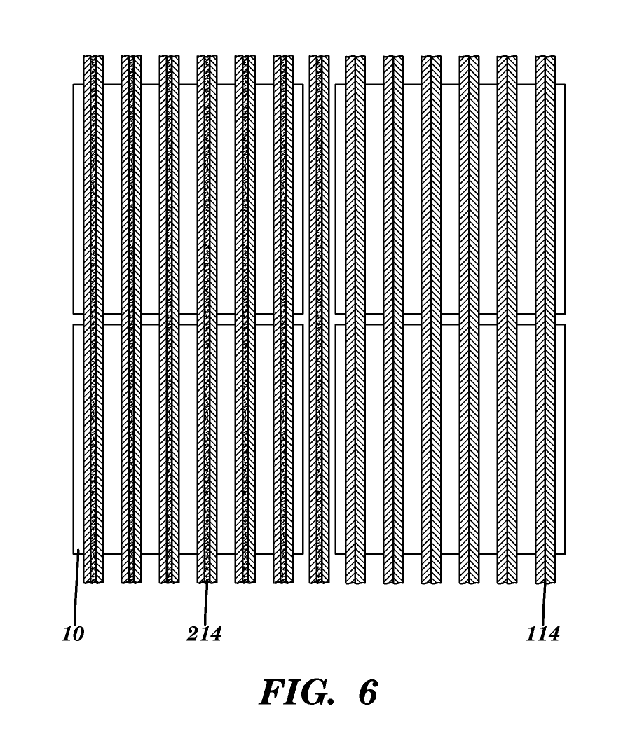

The grooves are typically either linear and parallel or arcuate and concentric, although other configurations are possible. In one embodiment of the present invention, the grooves extend horizontally across the optical device 100. In another embodiment, as illustrated in FIG. 6, the grooves extend vertically across the optical device 100. In yet another embodiment, the microstructure layer 101 includes multiple sets of grooves. For example, the multiple sets of grooves can be positioned such that they are cross-hatched (bi-directional) wherein two sets of grooves are orthogonal to each other or three sets of grooves can be positioned so that they are rotationally 60 degrees apart. Furthermore, two or more sets of optical devices 100 can be used, either crossed or running parallel (either vertically, horizontally, or some other arbitrary angle to minimize moiré).

Referring to FIGS. 2 and 3, the triangular-shaped grooves are filled with an opaque material 114 to create alternating transparent and opaque sections on surface 108 of the microstructure layer 101. Alternately the triangular-shaped grooves can be partially filled with an opaque material 114 as long as the sides of the grooves are coated with the opaque material. In this case the void behind the partially filled triangular-shaped groove could be filled with a second material, or it can be left vacant. The opaque material 114 has a light absorbing characteristic. Also referring to FIG. 2, the distance D between adjacent opaque sections 114 is from about 0.01 mm to about 1 mm and the width B of the opaque sections 114 is from about 0.005 mm to about 0.5 mm. Suitable opaque materials 114 include, but are not limited to, a UV curable resin, a solvent-cured material, a paint, a heat-curing material, or any other material that polymerizes without the use of UV radiation. In one embodiment, light absorbing particles are mixed into, for example, a UV curable resin to form the opaque material 114. Suitable light absorbing particles include, but are not limited to, carbon, dyes, inks, or stains.

In one embodiment, the opaque material 114 has a refractive index of from about 1.4 to about 1.6. In one particular embodiment of the present invention, the refractive index of the microstructures 102 and opaque material 114 are substantially equal. This reduces fresnel reflection of light (both ambient light and light emitted from the display). In one preferred embodiment, the difference in refractive indices between the transparent microstructures 102 and the opaque material 114 is 0.03 or less. In another preferred embodiment, the refractive index of the opaque material 114 is greater than the refractive index of the microstructure 102 so that Total Internal Reflection of ambient light or light emitted from a pixel 10 does not occur at the interface between the two materials.

In addition, the opaque material 114 preferably has an optical density greater than 1.0, most preferably greater than 3.0, and superior ambient light absorbance is achieved when the optical density is 5.0 or more.

In yet another embodiment, the opaque material 114 is composed of a dielectric material. However, in alternate embodiments, the opaque material may contain metallic components, particularly light-absorbing ferrous materials that can be magnetically mixed, dispersed, or deposited throughout a dielectric matrix of a supporting medium. The opaque material 114 may also contain particles of metallic oxides.

In a further embodiment, a non-symmetric microstructure 102, such as a parallelogram cross-section, or slanted trapezoid, can be tailored to produce opaque regions 114 that preferentially absorb ambient light from a predetermined direction, such as from overhead.

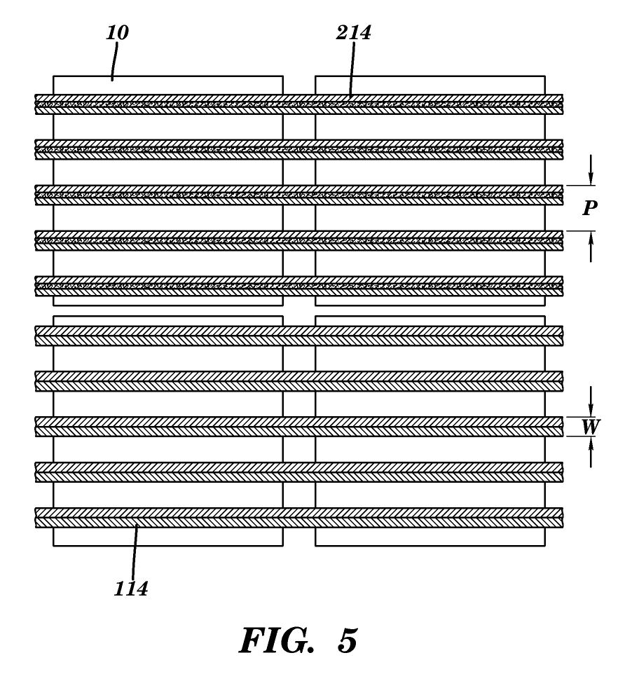

FIG. 5 is a front view of the present invention, showing the pixels 10 of the display panel in the background behind the opaque material 114 and 214 (described below). A duty factor of the opaque material 114 can be defined as the ratio of the width of the widest part of an opaque material 114, designated as “W” in FIG. 5 divided by the pitch, P. That is, the duty factor D=W/P. Larger duty factors allow for greater light absorption while smaller duty factors allow for greater display light transmittance through the optical device 100. A typical value for D is 0.15, although it can range from about 0.05 up to about 0.85.

The absorbance of the opaque material 114 should not be spectrally dependent, but instead should absorb all wavelengths approximately the same between 400 nm and 700 nm so that it does not impart a strong tint to the viewed image. However, if a mild tint is imparted, the spectral emissive properties of the display panel can be changed to reduce or eliminate the effect. Alternately, tinting can be intentionally added to the opaque material 114 to compensate for spectral irregularities of the light emitted by the display panel. Furthermore, IR absorbing additives can be added to the opaque material 114 that reduce the amount of infra-red light that is emitted by the display. Such IR emissions have been known to disrupt IR-based handheld remote controls, and blocking these emissions would be beneficial.

In another embodiment, the grooves filled with opaque material 114 have an aspect ratio, defined as the ratio of H/B (see FIG. 2), of greater than one for optimal ambient light absorption as described below. The material of the opaque material 114, the transparent microstructure 102, or both can have elastomeric properties to facilitate molding of the high aspect ratio microstructure.

Referring to FIG. 5, in one embodiment, the microstructures 102 have a pitch P of from about 10 μm to about 1 mm, which should be much less than the width of a pixel 10 so that moiré interference does not occur. The pitch of the microstructures can be such that there are at least two, and preferably five or more, transparent microstructures 102 per pixel 10 of the viewing display.

In one exemplary embodiment, the thickness of the optical device 100 including the substrate 118 and microstructure layer 101 is less than about 1 mm, preferably in the range of from about 0.1 mm to about 2.5 mm. In general it is desirable to keep the thickness of the optical device 100 as small as possible, in keeping with the trend to thinner displays, and the total thickness can be kept as low as 0.45 mm (0.02 mm for an adhesive layer, 0.10 mm microstructure layer 101, and 0.15 mm substrate 118 thickness) although other thicknesses can be provided to best suit the application.

Referring to FIG. 2, second surface 108 of the microstructure layer 101 is adhered to an output surface of a front face panel 12 of a viewing display using an adhesive layer 104, such as a pressure sensitive adhesive (PSA). Alternatively, the optical device 100 can be installed onto a light-transmissive sheet of material that is then placed in front of the display panel. The transmittance of the adhesive layer 104 should not be spectrally dependent, but instead should transmit all wavelengths approximately the same between 400 nm and 700 nm so that it does not impart a strong tint to the viewed image. However, if a mild tint is imparted to the adhesive layer 104, the spectral emissive properties of the display panel can be changed to reduce or eliminate the effect. Alternately, tinting can be intentionally added to the adhesive layer 104 to compensate for spectral irregularities of the light emitted by the display panel. Furthermore, IR absorbing additives can be added to the adhesive layer to reduce the amount of infra-red light that is emitted by the display. Such IR emissions have been known to disrupt IR-based handheld remote controls, and blocking these emissions would be beneficial.

In one exemplary embodiment, the refractive index of the adhesive layer 104 is between that of the microstructures 102 and the output surface of the viewing display 12 to reduce unwanted fresnel reflections at these interfaces.

In one embodiment, the viewing display is a flat panel display. Suitable viewing displays include, but are not limited to, pixelated displays, such as plasma display panels, LCD display panels, iLED display panels, and OLED display panels. FIGS. 2-4 show examples of pixelated displays including pixels 10A, 10B, and 10C. In another embodiment, the display panel is curved, and the optical device 100 of the present invention can be formed to fit the curvature of such a non-flat device.

In one embodiment, referring to FIGS. 2-4, the present invention relates to a method of making an optical device 100/200. This method involves providing a transparent substrate 118/218 and applying a microstructure layer 101/201 having first and second opposing surfaces 106/206 and 108/208. In accordance with one embodiment, the microstructure layer 101/201 is cast on substrate 118/218 with a casting process in which a UV curable resin is placed into a microstructured mold which is then brought into contact with the substrate 118/218, and then the UV curable resin is exposed to UV light which polymerizes the resin and causes it to harden and attach to the substrate 118/218. The mold is then removed. This process is typically done in a continuous roll-to-roll process in which the mold is in the form of a cylinder in which a negative of the microstructures 102/202 is formed into the surface, and then the UV resin and substrate 118/218 are continually rolled over the mold's surface as it rotates about its axis. A tie coat, such as PET or acrylic, can be provided between the UV-curable resin and the substrate to improve the adhesion of the UV cured material to the substrate.

Alternately, the microstructure layer 101/201 can be formed directly into the substrate by the use of an embossing molding process, a compression molding process, or an injection molding process.

Next the grooves are filled with opaque material 114/214. Filling can be achieved by methods known to one of ordinary skill in the art. In particular, the opaque material, 114 and 214, can be installed between the transparent microstructures 102 and 202, respectively, in any of a number of different ways. By way of example only, the grooves and transparent microstructures 102 and 202 can both be sprayed with the opaque material, and the transparent microstructures can be wiped or squeegeed so that they are free of the opaque material, with the result that the opaque material is only present in the grooves. Alternately, the opaque material can simply be squeegeed across the grooves and transparent microstructures 102 and 202 with the result that the transparent microstructures are free of the opaque material but the opaque material will be present in the grooves. Yet another method is to use a pair of nip rollers to force the opaque material into the grooves (and leave the microstructures 102 and 202 substantially free of the opaque material) as the optical device 100/200, with a bead of opaque material at the nip, passes between the rollers. The surface 108/208 of the microstructure layer 101/201 is then attached to the output surface of the viewing display 12 using an adhesive 104/204, resulting in the final construction shown in FIGS. 2-4.

Referring back to FIG. 2, the operation of the device 100 can be illustrated by describing how a few different types of rays interact with the device 100. Ambient light ray 130 originates at an ambient light source, such as an overhead room lamp, or it could be reflected off of a wall of a room of the ambient environment. Regardless of its source, it is highly desirable to prevent ambient light ray 130 from being reflected back into the viewing environment. Ambient light ray 130 refracts through the first surface 120 of a substrate 118 of the optical device 100, and thereafter enters into the transparent microstructure 102. After propagating some distance into the transparent microstructure 102, the ambient light ray 130 becomes incident upon a groove filled with opaque material 114 at location 140. If the refractive index of the opaque material 114 is substantially the same as the refractive index of the transparent microstructure 102, then ambient light ray 130 will be substantially absorbed at location 140, regardless of the angle of incidence of the ambient light ray 130 at location 140. In this way, good ambient light absorption is achieved.

Ambient light ray 130 also illustrates an advantage of the present invention over the prior art. If the grooves of opaque material 114 were instead replaced with thin opaque stripes 14 of the prior art, then ray 130 would not be absorbed at location 140, but instead would propagate along path 131 and pass through a transparent section at location 141. This ray would then be backreflected by pixel 10A, seen by a viewer, and result in an apparent reduction in screen black level.

Consider another ambient light ray 132. This ray passes through the first surface 120 of the substrate 118, and passes through the transparent microstructure 102, a transparent section 142, the glass layer 12, and eventually reaches a substantially reflective pixel 10A at location 144. This ray is then diffusely back-reflected at location 144 into several rays including ray 134 and ray 136. Ray 136 is then absorbed at location 148 at the base of a triangular-shaped groove filled with opaque material 114, and does not contribute to a reduction in display black level. On the other hand ray 134 is not absorbed by a groove filled with opaque material 114, and exits the optical device 100 and does contribute to a reduction in screen black level. The present invention can reduce the amount of ambient light that is backreflected by 80%, and in some cases more than 95%.

Fortunately rays such as ray 134 are in the minority, as most rays are incident on the base of a triangular-shaped groove filled with opaque material 114 as seen with ray 136, or are incident on the side of a groove filled with opaque material 114, as seen with ray 137. Ray 137 is absorbed at location 166 on the side of a groove filled with opaque material 114, and does not contribute to a reduction in screen black level. Note, however, that if the groove filled with opaque material 114 were replaced with thin opaque stripes 14 of the prior art, then ray 137 would instead exit the optical device 100 and contribute to a reduction in screen black level.

Now consider light rays emitted by the display panel pixels themselves, such as light rays 162, 164, and 168 emitted by pixel 10B at locations 150, 152, and 154. Emitted light ray 162 is absorbed at the base of a triangular-shaped groove filled with opaque material 114 at location 158, and reduces the apparent brightness of the display panel. Light ray 164 passes through an transparent section 156 and subsequently passes through the optical device 100 and contributes to the brightness of the display panel. The optical device 100 of the present invention will reduce the amount of transmitted light (emitted by the display panel) by less than 50%, although in some cases it may approach 75%, or be as little as 20%, depending on the ambient light absorbing characteristics of the film.

Light ray 168 exits the pixel 10B at an oblique angle and is subsequently incident on the side of a groove filled with opaque material 114 at location 170. Light ray 168 is nominally absorbed, but if the refractive index of the clear microstructure 102 is different than the refractive of the opaque material 114, then a reflection ray 172 exists. To a viewer, reflection ray 172 appears to originate at pixel 10C, by way of virtual ray 174 which appears to originate at location 176. To the viewer, then, pixel 10B and pixel 10C appear to overlap to some extent, and results in a phenomenon that will be referred to as “pixel blur”. This pixel blur manifests itself as a reduction in spatial resolution of the display panel.

However, pixel blur can be easily remedied by substantially matching the refractive index of the opaque material 114 to the refractive index of the transparent microstructure 102, as this will reduce or eliminate the Fresnel reflection, or Total Internal Reflection (TIR) that can occur at the point of incidence.

The analysis of the light reflection at the interface between the opaque material 114 and the transparent microstructure 102 can be facilitated by referring to FIG. 3. In this figure, θ₁ is the angle of incidence that the emitted ray 168 makes at the interface between the opaque material 114 and the transparent microstructure 102; θ_{T} is the angle of exittance of the light ray transmitted into the opaque material 114; θ_{C}=90°−θ₁; θ_{S} is the slope angle of the sidewalls of the grooves filled with the opaque material 114 relative to a normal line 184 and is typically less than 15°; θ_{PV} is the apparent emission angle of virtual ray 174 as it leaves a pixel 10C at location 176; θ_{PR} is the emission angle of real ray 168 as it leaves a pixel 10B at location 154; and θ_{Out} is the final output angle of the light ray 172 as it leaves the display panel relative to a normal line 182. By inspection:

θ_{C}=θ_{PR}−θ_{S} (Equation 1)

θ_{PV}=2θ_{C}−θ_{PR} (Equation 2)

Sin(θ_{Out})=n_{C} Sin(θ_{PV}) (Equation 3A)

θ_{Out}=A sin [n_{C} Sin(θ_{PV})] (Equation 3B)

n_{C} Sin(θ₁)=n_{O} Sin(θ_{T}) (Equation 4A)

θ_{T}=A sin [n_{C} Sin(θ₁)/n_{O}] (Equation 4B)

where n_{C} is the refractive index of the transparent microstructure 102 and n_{O} is the refractive index of the opaque material 114.

As discussed above, it is highly desirable to minimize the power in reflected rays 172, which is accomplished by controlling the relative refractive indices of the opaque material 114 and the transparent microstructure 102. The amount of power in the reflected rays 172 is known to follow the Fresnel reflection equations. There are two Fresnel equations which are used to compute the amount of reflected power: one for light whose E-field is oriented perpendicular to the plane of incidence (s-polarization), and another for light whose E-field is oriented parallel to the plane of incidence (p-polarization). These two equations are:

$$\begin{matrix}{R}_{s} = {[ \frac{{n}_{C} cos ( {θ}_{I} ) - {n}_{O} cos ( {θ}_{T} )}{{n}_{C} cos ( {θ}_{I} ) + {n}_{O} cos ( {θ}_{T} )} ]}^{2} & ( Equation 5 ) \\ {R}_{p} = {[ \frac{{n}_{C} cos ( {θ}_{T} ) + {n}_{O} cos ( {θ}_{I} )}{{n}_{C} cos ( {θ}_{T} ) - {n}_{O} cos ( {θ}_{I} )} ]}^{2} & ( Equation 6 )\end{matrix}$$

Given that the light emitted by a display panel's pixel is generally randomly polarized, containing 50% P-polarization and 50% S-polarization, the total reflectance becomes an average of these two:

%R=(R_{S}+R_{P})/2×100% (Equation 7)

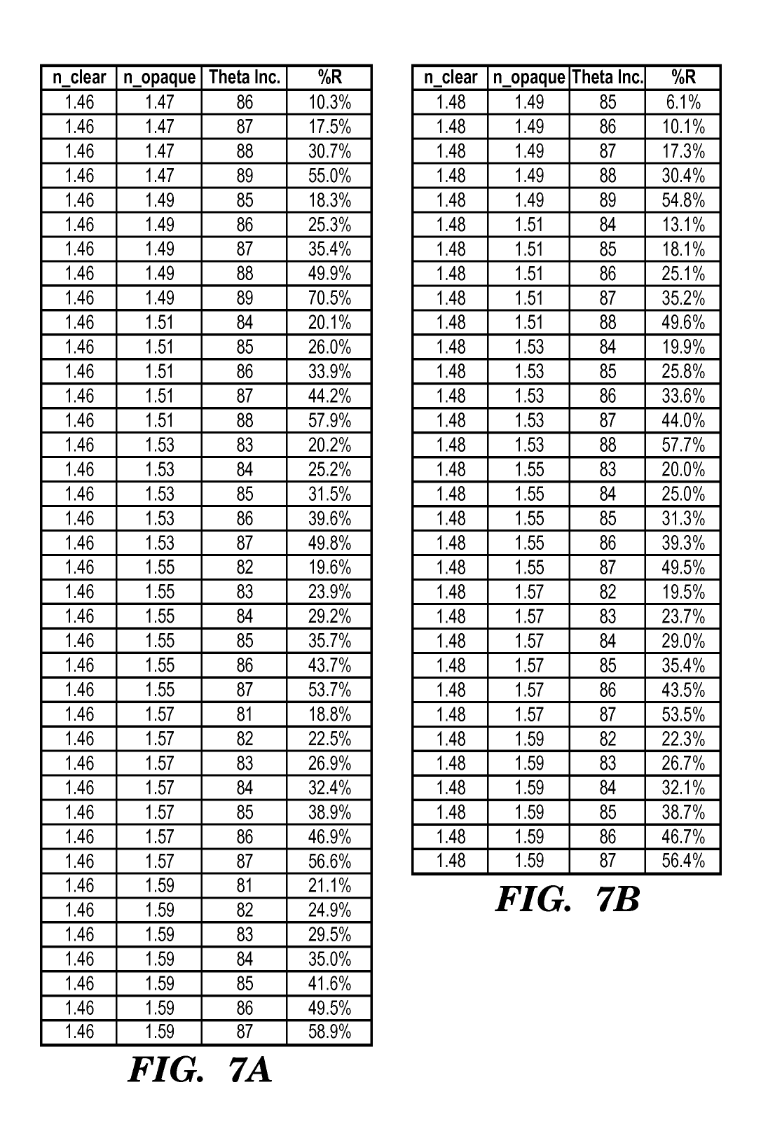

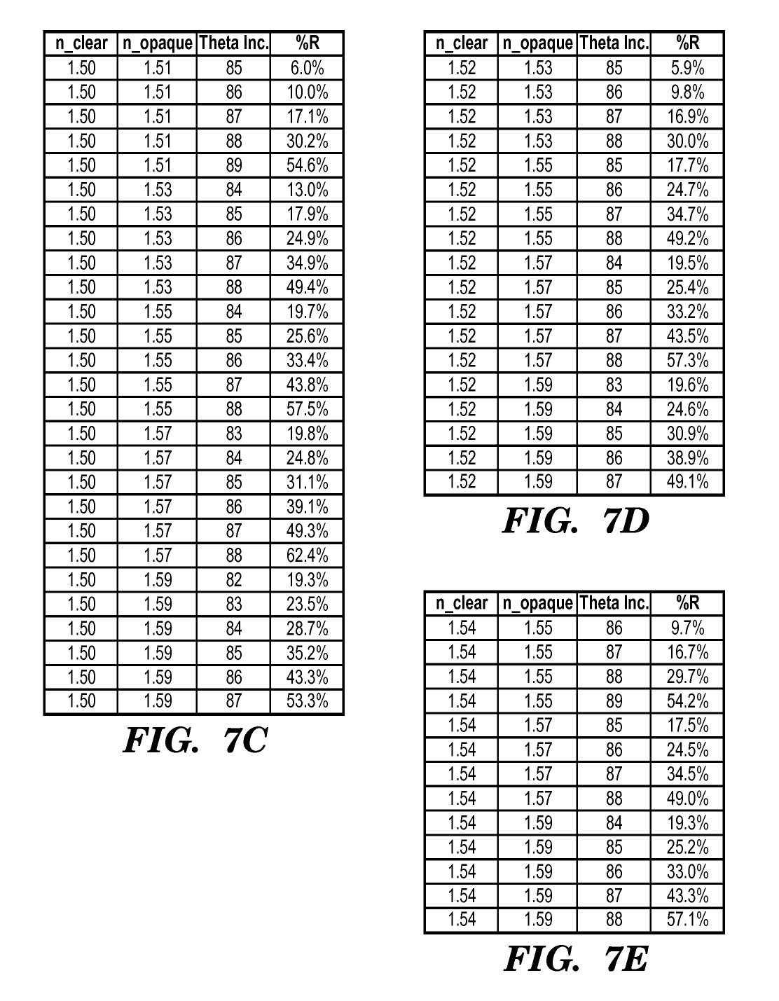

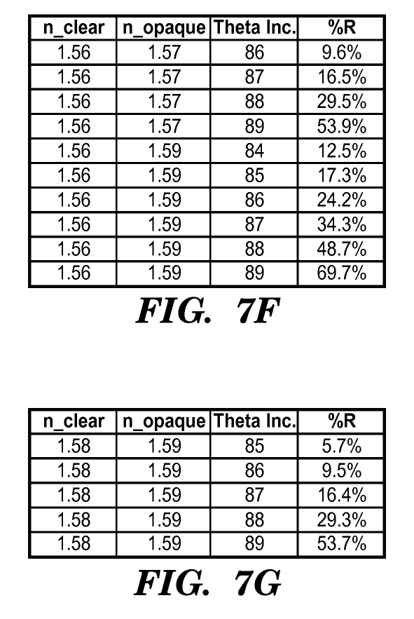

The tables in FIGS. 7A-G present the percentage amount of power in the reflected ray (column % R) compared to the amount of power in the incident ray, as a function of various values of incidence angle (Theta Inc. or θ₁), refractive index of the transparent (clear) microstructure 102 (n_clear or n_{C}), and refractive index of the opaque material 114 (n_opaque or n_{O}). As a general rule of thumb, for the pixel-blur to be minimized, the amount of power in the reflected ray should be less than 10% of the amount of power in a ray emitted by a pixel, but preferably the amount of reflected power should be less than 2%, for any given angle of incidence. This condition occurs when the refractive index difference is less than 0.01, although differences as high as 0.03 may be acceptable for some applications. Furthermore, the refractive index of the opaque material 114 should be greater than the refractive index of the transparent microstructure 102 in order to avoid total internal reflectance (TIR) conditions which can occur at large values of θ₁ and small differences in refractive index. TIR can produce 100% reflectance, which clearly will result in objectionable pixel blur.

One potential problem with the film construction depicted in FIG. 2 is that for large aspect ratio grooves, where H/B>1.5, it can be difficult to produce a mold for the microstructure or it can be difficult to separate the microstructure 102 from the mold, or both problems can occur. A remedy is to simply change the design so that the transparent microstructures 102 and the grooves filled with opaque material 114 have trapezoidal shapes, or some other shape having small values of θ_{S} and H/B<1.5.

Referring back to FIG. 4, one such alternate configuration is shown in which θ_{S} is small and H/B<1.5. This configuration was obtained by simply removing the peaked portions of the opaque material 114 and adjacent transparent microstructure 102 material. The resulting opaque material 214 is now trapezoidal in cross-section. The operation of this embodiment is similar to that described in connection with FIGS. 2 and 3 and is briefly described below, although the ambient light absorption will be somewhat reduced because the surface area of the sides of the opaque material 214 is reduced. This compromise is often justified as the small reduction in performance is more than offset by the reduced cost of production.

Referring to FIG. 4, ambient light ray 230 originates at an ambient light source. Ambient light ray 230 refracts through the first surface 220 of a substrate 218 of the optical device, and thereafter enters into the transparent microstructure. After propagating some distance into the transparent microstructure, the ambient light ray 230 becomes incident upon a groove filled with opaque material 214 at location 240. At this point ambient light ray 230 is absorbed and does not have the opportunity to be scattered or otherwise back-reflected to the viewer and thereby degrade the black-level performance of the display.

Consider another ambient light ray 232. This ray passes through the first surface 220 of the substrate 218, and passes through the transparent microstructure, a transparent section 242, the glass layer 12, and eventually reaches a substantially reflective pixel 10A at location 244. This ray is then diffusely back-reflected at location 244 into several rays including ray 234 and ray 236. Ray 236 is then absorbed at location 248 at the base of a trapezoidal-shaped groove filled with opaque material 214, and does not contribute to a reduction in display black level. On the other hand ray 234 is not absorbed by a groove filled with opaque material 214, and exits the contrast enhancing film and does contribute to a reduction in screen black level. This embodiment of the present invention can reduce the amount of ambient light that is backreflected by 50%, and in some cases more than 95%.

As described above, rays such as ray 234 are in the minority, as most rays are incident on the base of a trapezoidal-shaped groove filled with opaque material 214 as seen with ray 236, or are incident on the side of a groove filled with opaque material 214, as seen with ray 237. Ray 237 is absorbed at location 266 on the side of a groove filled with opaque material 214, and does not contribute to a reduction in screen black level. Note, however, that if the groove filled with opaque material 214 were replaced with thin opaque stripes 14 of the prior art, then ray 237 would instead exit the contrast enhancement film and contribute to a reduction in screen black level.

Now consider light rays emitted by the display panel pixels themselves, such as light rays 262 and 264 emitted by pixel 10B at locations 250 and 252. Emitted light ray 262 is absorbed at the base of a trapezoidal-shaped groove filled with opaque material 214 at location 258, and reduces the apparent brightness of the display panel. Light ray 264 passes through transparent section 256 and subsequently passes through the optical device 100 and contributes to the brightness of the display panel. The optical device 100 of the present invention will reduce the amount of transmitted light (emitted by the display panel) by less than 50%, although in some cases it may approach 75%, or be as little as 20%, depending on the ambient light absorbing characteristics of the film.

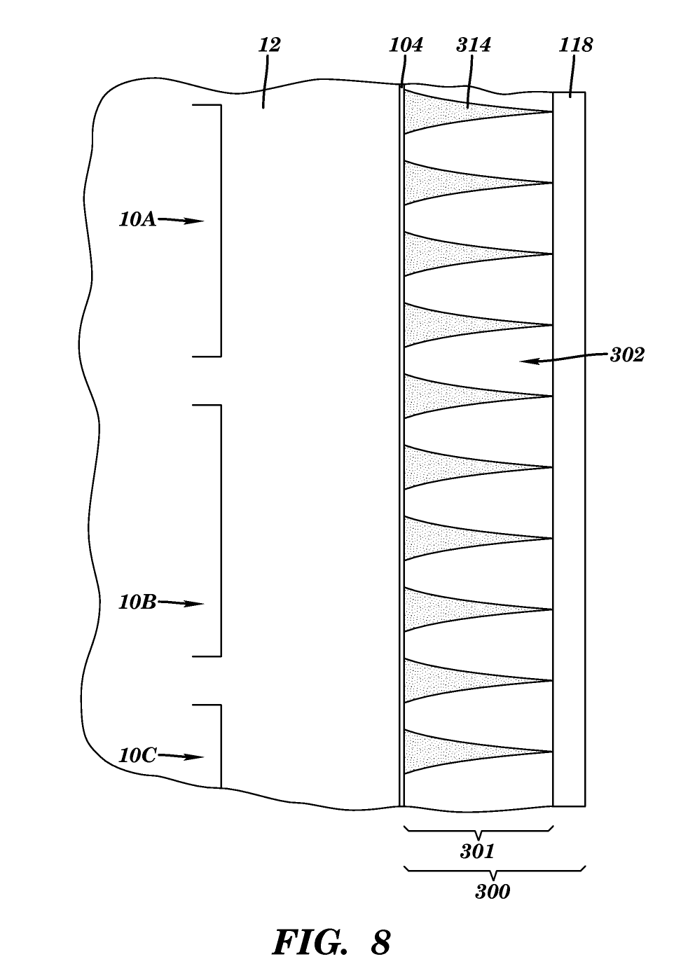

One alternate microstructure configuration is shown in FIG. 8 where the transparent microstructure 302 has sides that are non-linear in cross-section or curved. Non-linear sides can have several potential advantages over a linear cross-sectional shape, such as the ability to fabricate molds or tools quickly and at a lower cost, faster and less costly molding processes, and better optical performance of the finished part.

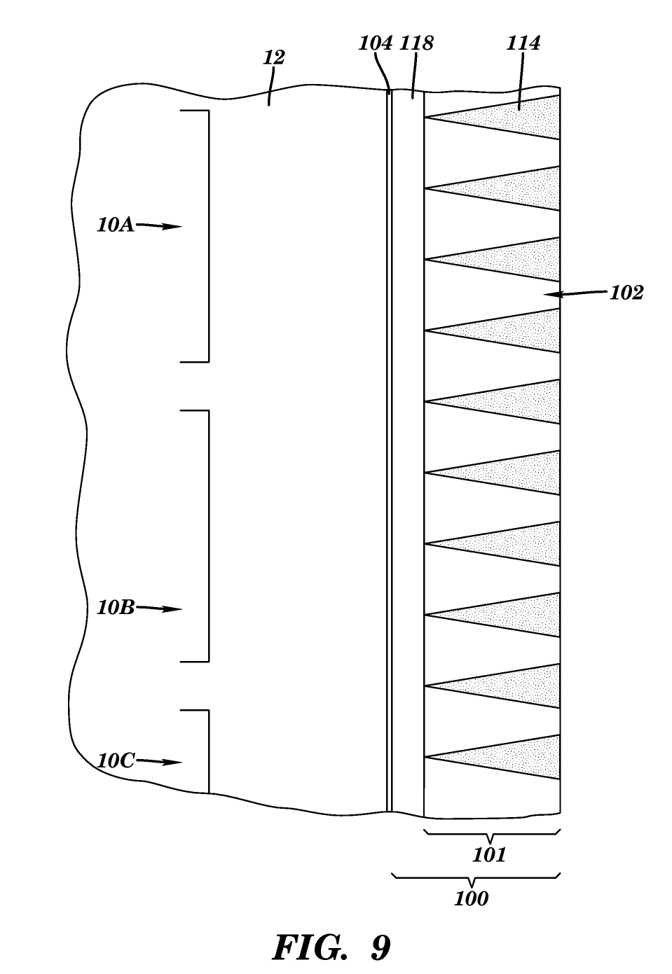

Another alternate embodiment is as shown in FIG. 9 where the optical device 100 is positioned in a reverse orientation wherein the substrate 118 is attached with PSA 104 onto the front face panel 12 of the display. The grooves filled with opaque material 114 are now facing the viewer. The operation of this configuration follows that as described in connection with FIGS. 2-4, including the relative refractive index values of the opaque material and the transparent microstructures 102.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. An optical device comprising:
a microstructure layer having first and second opposing surfaces, wherein the microstructure layer comprises a plurality of transparent microstructures which form a plurality of spaced grooves, said grooves being at least partially filled with an opaque material and positioned to create alternating opaque and transparent sections having refractive index values within 0.03; and
a transparent substrate adjacent at least a portion of the first surface of the microstructure layer.

2. The optical device according to claim 1, wherein the refractive index of the opaque material is greater than the refractive index of the plurality of transparent microstructures.

3. The optical device according to claim 1, wherein the plurality of transparent microstructures have a cross-sectional shape which is at least one of triangular, trapezoidal, rectangular, and square.

4. The optical device according to claim 1, wherein the plurality of grooves have a cross-sectional shape which is at least one of triangular, trapezoidal, rectangular, and square.

5. The optical device according to claim 1, wherein the plurality of transparent microstructures have an aspect ratio of from about 0.5 to about 3.0.

6. The optical device according to claim 1, wherein the plurality of transparent microstructures have a pitch that is from about 1 μm to about 10 mm.

7. The optical device according to claim 1, wherein the duty factor of the opaque sections is from about 0.1 to about 0.9.

8. The optical device according to claim 1, wherein the plurality of transparent microstructures extend horizontally across the optical device.

9. The optical device according to claim 1, wherein the plurality of transparent microstructures extend vertically across the optical device.

10. The optical device according to claim 1, wherein the thickness of the optical device is from about 0.1 mm to about 2.5 mm.

11. The optical device according to claim 1, wherein sides of the opaque sections are linear.

12. The optical device according to claim 1, wherein sides of the opaque sections are curved.

13. The optical device according to claim 1, wherein the opaque sections taper toward the substrate.

14. A system comprising:
an optical device comprising:
a microstructure layer having first and second opposing surfaces, wherein the microstructure layer comprises a plurality of transparent microstructures which form a plurality of spaced grooves, said grooves being at least partially filled with an opaque material and positioned to create alternating opaque and transparent sections having refractive index values within 0.03; and
a transparent substrate adjacent at least a portion of the first surface of the microstructure layer; and
a viewing display, wherein the second surface of the microstructure layer is adjacent at least a portion of the viewing display.

15. The system according to claim 14, wherein the refractive index of the opaque material is greater than the refractive index of the plurality of transparent microstructures.

16. The system according to claim 14, wherein the plurality of transparent microstructures have a cross-sectional shape which is at least one of triangular, trapezoidal, rectangular, and square.

17. The system according to claim 14, wherein the plurality of grooves have a cross-sectional shape which is at least one of triangular, trapezoidal, rectangular, and square.

18. The system according to claim 14, wherein the plurality of transparent microstructures have an aspect ratio of from about 0.5 to about 3.0.

19. The system according to claim 14, wherein the plurality of transparent microstructures have a pitch that is from about 1 μm to about 10 mm.

20. The system according to claim 14, wherein the duty factor of the opaque sections is from about 0.1 to about 0.9.

21. The system according to claim 14, wherein the plurality of transparent microstructures extend horizontally across the optical device.

22. The system according to claim 14, wherein the plurality of transparent microstructures extend vertically across the optical device.

23. The system according to claim 14, wherein the thickness of the optical device is from about 0.1 mm to about 2.5 mm.

24. The system according to claim 14, wherein sides of the opaque sections are linear.

25. The system according to claim 14, wherein sides of the opaque sections are curved.

26. The system according to claim 14, wherein the opaque sections taper away from the viewing display.

27. The system according to claim 14, wherein the opaque sections taper toward the viewing display.

28. The system according to claim 14, wherein the viewing display is at least one of a plasma display panel, a liquid crystal display panel, an inorganic light emitting diode display panel, and an organic light emitting diode display panel.

29. The system according to claim 28, wherein the display panel is a plasma display panel.

30. A method for improving black level of a viewing display comprising:
providing an optical device comprising:
a microstructure layer having first and second opposing surfaces, wherein the micro structure layer comprises a plurality of transparent micro structures which form a plurality of spaced grooves, said grooves being at least partially filled with an opaque material and positioned to create alternating opaque and transparent sections having refractive index values within 0.03; and
a transparent substrate adjacent at least a portion of the first surface of the micro structure layer; and
positioning at least a portion of the second surface of the microstructure layer adjacent at least a portion of an output surface of a viewing display, wherein a portion of ambient light is absorbed by the optical device before reaching the viewing display and a portion of ambient light reflected from the viewing display is absorbed by the optical device.

31. The method according to claim 30, wherein the refractive index of the opaque material is greater than the refractive index of the plurality of transparent microstructures.

32. The method according to claim 30, wherein the plurality of transparent microstructures have a cross-sectional shape which is at least one of triangular, trapezoidal, rectangular, and square.

33. The method according to claim 30, wherein the grooves have a cross-sectional shape which is at least one of triangular, trapezoidal, rectangular, and square.

34. The method according to claim 30, wherein the plurality of transparent microstructures have an aspect ratio of from about 0.5 to about 3.0.

35. The method according to claim 30, wherein the plurality of transparent microstructures have a pitch that is from about 1 μm to about 10 mm.

36. The method according to claim 30, wherein the duty factor of the opaque sections is from about 0.1 to about 0.9.

37. The method according to claim 30, wherein the plurality of transparent microstructures extend horizontally across the optical device.

38. The method according to claim 30, wherein the plurality of transparent microstructures extend vertically across the optical device.

39. The method according to claim 30, wherein the thickness of the optical device is from about 0.1 mm to about 2.5 mm.

40. The method according to claim 30, wherein sides of the opaque sections are linear.

41. The method according to claim 30, wherein sides of the opaque sections are curved.

42. The method according to claim 30, wherein the opaque sections taper away from the viewing display.

43. The method according to claim 30, wherein the opaque sections taper toward the viewing display.

44. The method according to claim 30, wherein the viewing display is at least one of a plasma display panel, a liquid crystal display panel, an inorganic light emitting diode display panel, and an organic light emitting diode display panel.

45. The method according to claim 44, wherein the display panel is a plasma display panel.
